(19) United States
(12) Patent Application Publication
(10) Pub. No.: US 2018/0044491 A1
(43) Pub. Date: Feb. 15, 2018

(54) ION-EXCHANGE MEMBRANE

(71) Applicant: KURARAY CO., LTD., Kurashiki-shi, Okayama (JP)

(72) Inventors: Taisuke KAMADA, Kurashiki-shi (JP); Masahiro BABA, Kurashiki-shi (JP)

(73) Assignee: KURARAY CO., LTD., Kurashiki-shi, Okayama (JP)

(21) Appl. No.: 15/552,172

(22) PCT Filed: Feb. 18, 2016
(86) PCT No.: PCT/JP2016/054753

§ 371 Date: Aug. 18, 2017

(30) Foreign Application Priority Data
Feb. 20, 2015 (JP) 2015-032174

(51) Int. Cl. C08J 5/22; C08F 293/00; B01J 41/14; C08F 261/04; B01J 47/12; B01J 39/20

(52) U.S. Cl. CPC C08J 5/2231; B01J 47/12; B01J 39/20; B01J 41/14; C08F 261/04; C08F 293/005

(57) ABSTRACT

The present invention provides a polyvinyl alcohol-based ion-exchange membrane having practical dimensional stability and electrodialysis performance, and a method for producing the ion-exchange membrane. The present invention relates to an ion-exchange membrane which gives an infrared absorption spectrum that satisfies the relationship (A):

30≦{Z−(X+Y)×30/2}/T (A)

wherein X is the absorbance at an absorption wavelength of 1690 cm⁻¹, Y is the absorbance at an absorption wavelength of 1720 cm⁻¹, Z is the integral value for the region lying between absorption wavelengths of 1690 cm⁻¹ and 1720 cm¹, and T (cm) is the thickness of the ion-exchange membrane.

### TECHNICAL FIELD

The present invention relates to an ion-exchange membrane having practical dimensional stability and electrodialysis performance.

### BACKGROUND ART

Ion-exchange membranes are used for various usages including, for example, concentration of seawater, desalination or removal of nitrate nitrogen of underground brine for drinking water, desalting in a food manufacturing process, concentration of an active ingredient in a pharmaceutical product and the like as ion-separation membranes used for an electrodialysis method, a diffusion dialysis method or the like. Major ion-exchange membranes used for these usages are styrene-divinylbenzene-based ion-exchange membranes and fluorocarbon-based ion-exchange membranes.

It is known that a styrene-divinylbenzene-based ion-exchange membrane is produced by introducing an anionic group such as a sulfonate group or a cationic group such as a quaternary ammonium group into a styrene-divinylbenzene-based copolymer by post-modification (Patent Documents 1 and 2). However, in the styrene-divinylbenezene-based polymer ion-exchange membrane, since the processability of the polymer is poor, it is necessary to impart a shape using a support during polymerization. Furthermore, since the post-modification treatment is required, there is a problem that the production cost increases.

It is known that a fluorocarbon-based ion-exchange membrane is produced using a perfluoroalkyl sulfonic acid-type polymer in which a sulfonate group is bound to a side chain of a perfluoroalkyl skeleton (Patent Document 3). However, in the fluorocarbon-based ion-exchange membrane, there are problems of a complicating polymer manufacturing process and of using a carbon fluoride material which makes it difficult to greatly reduce the cost.

Recently, an ion-exchange membrane using a polyvinyl alcohol-based copolymer, which has excellent ion exchange capacity and permselectivity, high processability as well as high resistance to organic fouling, and enables cost reduction, has been reported and attracted attention (Patent Documents 4 and 5). However, in the ion-exchange membrane using the polyvinyl alcohol-based copolymer, since a hydrophilic polyvinyl alcohol is usually used as a base material, insoluble treatment by a divalent hydroxyl group crosslinking agent such as glutaraldehyde or a hydroxyl group modifier such as formaldehyde is indispensable. Furthermore, the ion-exchange membrane sometimes has a high water content and poor dimensional stability even after the insoluble treatment, and therefore further improvement is needed.

### PRIOR ART DOCUMENTS

### Patent Documents

Patent Document 1: JP 2008-266443 A

Patent Document 2: JP 2008-285665 A

Patent Document 3: JP 2005-78895 A

Patent Document 4: JP 4776683 B

Patent Document 5: International Publication Pamphlet 2010/110333 A1

### SUMMARY OF INVENTION

### Problem to be Solved by the Invention

It is an object of the present invention to provide a vinyl alcohol-based ion-exchange membrane having practical dimensional stability and electrodialysis performance.

### Means for Solving the Problem

The present inventors intensively studied in detail about various ion-exchange membranes in order to solve the above problem, thereby completing the present invention.

That is, the present invention includes the following preferred embodiments.

[1] An ion-exchange membrane which gives an infrared absorption spectrum that satisfies the relationship shown by formula (A):

[Numerical Formula 1]

30≦{Z−(X+Y)×30/2}/T (A)

wherein X is the absorbance at an absorption wavelength of 1690 cm⁻¹, Y is the absorbance at an absorption wavelength of 1720 cm⁻¹, Z is the integral value for the region lying between absorption wavelengths of 1,690 cm⁻¹ and 1,720 cm⁻¹, and T is the thickness of the ion-exchange membrane.
[2] The ion-exchange membrane according to the above [1], containing a polyvinyl alcohol-based polymer or a composition comprising the polymer.
[3] The ion-exchange membrane according to the above [2], wherein the polyvinyl alcohol-based polymer or the composition containing the polymer contains an ionic group.
[4] The ion-exchange membrane according to the above [3], wherein the ionic group is an anionic group.
[5] The ion-exchange membrane according to the above [3], wherein the ionic group is a cationic group.
[6] A method for producing the ion-exchange membrane according to any one of the above [1] to [5], comprising heat-treating a polyvinyl alcohol-based polymer or a composition containing the polymer.
[7] The production method according to the above [6], wherein the polymer is a block copolymer (BP) shown by the following general formula (1):

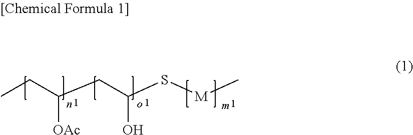

wherein 0.5000≦o¹/(n¹+o¹)≦0.9999; 0.01≦m¹/(m¹+n¹+O¹)≦0.50; M is a structural unit derived from a monomer M′ having an anionic group or a cationic group.
[8] The production method according to the above [6], wherein the polymer is a graft copolymer (GP) shown by the following general formula (2):

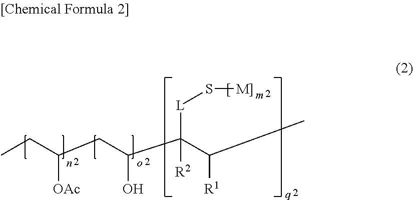

wherein 0.5000≦o²/(n²+o²)≦0.9999; 0.001≦q²/(n²+o²+q²)≦0.05; 0.01≦q²m²/(q²m²+n²+o²)≦0.50; R¹ is a hydrogen atom or a carboxyl group; R² is a hydrogen atom, a methyl group, a carboxyl group or a carboxymethyl group; L is a divalent aliphatic hydrocarbon group having 1 to 20 carbon atoms optionally containing a nitrogen atom and/or an oxygen atom; when R¹ is a carboxyl group or when R² is a carboxyl group or a carboxymethyl group, R¹ and R² may each form a ring with an adjacent hydroxyl group; and M is a structural unit derived from a monomer M′ having an anionic group or a cationic group.

### Effect of the Invention

The ion-exchange membrane of the present invention that satisfies the relationship shown by the above formula (A) has practical dimensional stability and electrodialysis performance.

### BRIEF DESCRIPTION OF DRAWINGS

FIG. 1 is a drawing for explaining formula (A) in an ion-exchange membrane of the present invention;

FIG. 2 is a cross-sectional view of a device used for measurement of a dynamic transport number of the ion-exchange membrane of the present invention; and

FIG. 3 is a cross-sectional view of a device used for measurement of membrane resistance of the ion-exchange membrane of the present invention.

### EMBODIMENTS OF THE INVENTION

An ion-exchange membrane which gives an infrared absorption spectrum that satisfies the relationship shown by formula (A):

[Numerical Formula 2]

30≦{Z−(X+Y)×30/2}/T (A)

wherein X is the absorbance at an absorption wavelength of 1690 cm⁻¹, Y is the absorbance at an absorption wavelength of 1720 cm⁻¹, Z is the integral value for the region lying between absorption wavelengths of 1,690 cm⁻¹ and 1,720 cm⁻¹ (the integral value of the absorbance), and T is the thickness of the ion-exchange membrane.

From the infrared absorption spectrum of the ion-exchange membrane of the present invention, a value calculated by the above formula {Z−(X+Y)×30/2}/T (hereinafter also referred to as parameter A) is 30 or more, preferably 50 or more. When the parameter A is the above lower limit or more, it is preferred since the ion-exchange membrane has high water resistance and electrodialysis performance. An upper limit of the parameter A is not particularly limited, for example, it may be 1000 or less, preferably 800 or less.

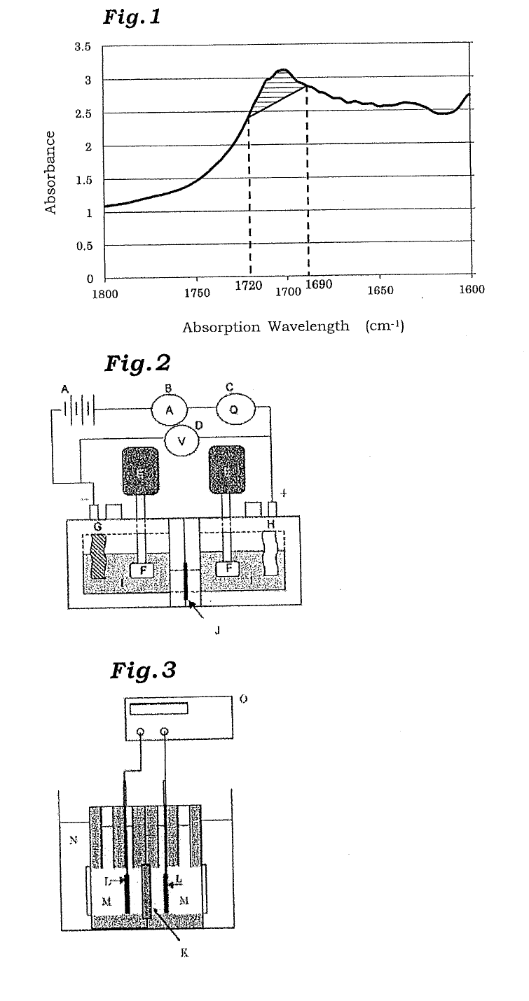

The parameter A is a parameter corresponding to the area of a projection of an absorption curve between absorption wavelengths of 1690 cm⁻¹ and 1720 cm⁻¹. Specifically, in an absorption spectrum shown in FIG. 1, for example, a shaded area obtained by subtracting, from the integral value (the integral value of the absorbance) Z for the region lying between absorption wavelengths of 1690 cm⁻¹ and 1720 cm⁻¹, a trapezoidal portion included in the region corresponds to the parameter A. It is considered that the parameter A increases as the number of ketone groups increases. When there are too few ketone groups in the ion-exchange membrane, water resistance of the ion-exchange membrane is insufficient, which is not preferred. Therefore, an ion-exchange membrane satisfying the relationship shown by the formula (A) is preferred. Furthermore, when there are too many ketone groups, the strength of the ion-exchange membrane is sometimes lowered.

The value of the parameter A can be raised, for example, by a method of performing a heat treatment described below, a method of raising the heat treatment temperature in the heat treatment, a method of lengthening the heat treatment time in the heat treatment, the method of adjusting the pH and the like. By these methods, the value of the parameter A can be adjusted within the above range.

The ion-exchange membrane of the present invention is not particularly limited as long as it is an ion-exchange membrane that satisfies the relationship shown by the formula (A), preferably an ion-exchange membrane containing a polymer having an ionic group. The ionic group is a cationic group or an anionic group. When the ion-exchange membrane contains a polymer having an anionic group, the ion-exchange membrane can be used as a cationic exchange membrane. When the ion-exchange membrane contains a polymer having a cationic group, the ion-exchange membrane can be used as an anionic exchange membrane.

When the ion-exchange membrane of the present invention contains a polymer having an ionic group, the amount of the ionic group is preferably 1-50 mol %, more preferably 3-30 mol %, and even more preferably 5-25 mol %, with a total of structural units of all polymers contained in the ion-exchange membrane as 100 mol %. When the amount of the ionic group is the upper limit or less, it is preferred since swelling of the ion-exchange membrane is easily suppressed. When the amount of the ionic group is the lower limit or more, it is preferred since ion exchange performance is easily enhanced by enhancement in ion conductivity.

Examples of the anionic group include, for example, a sulfonate group, a phosphate group, a carboxylic acid group, a boronic acid group, a sulfonylimide group, and the like. A counter cation is not particularly limited, preferably a monovalent cation such as an alkali metal ion, H⁺ or a quaternary ammonium ion.

Examples of the cationic group include, for example, amino groups such as a non-substituted amino group, an N-alkylamino group, and an N-dialkylamino group; nitrogen-containing heterocyclic rings such as a pyridyl group and an imidazolyl group; and quaternary ammonium groups such as an N-trialkylammonium group, an N-alkyl pyridinium group, an N-alkylimidazolium group, a thiouronium group, and an isothiouronium group. A counter anion for the quaternary ammonium group is not particularly limited, preferably halogenated anions of Group 5B elements, such as PF₆⁻, SbF₆⁻, and AsF₆⁻, halogenated anions of Group 3B elements such as BF4⁻, halogen anions such as I⁻ (I₃⁻), Br⁻, and Cl⁻, halogen acid anions such as ClO₄⁻, metal halide anions such as AlCl₄⁻, FeCl₄⁻, and SnCl₅⁻, a nitrate anion shown by NO₃⁻, organic sulfonate anions such as p-toluenesulfonate anion, naphthalenesulfonate anion, CH₃SO₃⁻, and CF₃SO₃⁻, carboxylate anions such as CF₃COO⁻, and C₆H₅COO⁻, and monovalent anions such as OH⁻.

The ion-exchange membrane of the present invention is not particularly limited as long as it is an ion-exchange membrane that satisfies the relationship shown by the formula (A), and preferably an ion-exchange membrane containing a polyvinyl alcohol-based polymer, for example, an ion-exchange membrane containing a polymer having polyvinyl alcohol units.

When the ion-exchange membrane of the present invention contains a polyvinyl alcohol-based polymer, for example, a polymer having polyvinyl alcohol units, the amount of the polyvinyl alcohol units is preferably 1-90 mol %, more preferably 5-80 mol %, even more preferably 10-60 mol %, with the total of the structural units of all the polymers contained in the ion-exchange membrane as 100 mol %. When the amount of polyvinyl alcohol units is the upper limit or less, it is preferred since swelling of the ion-exchange membrane is easily suppressed. When the amount of the polyvinyl alcohol units is the lower limit or more, it is preferred since ion exchange performance is easily enhanced by enhancement in ion conductivity. Here, the polymer having the polyvinyl alcohol units may be a different polymer from the polymer having the ionic group, or may be the same polymer as the polymer having the ionic group. Here, the fact that the polymer having the polyvinyl alcohol units and the polymer having the ionic group are the same polymer shows that the ion-exchange membrane of the present invention contains the polymer having the ionic group and the polyvinyl alcohol units.

Examples of the polyvinyl alcohol units include, for example, polyvinyl alcohol units derived from a polyvinyl alcohol-based homopolymer, and a polyvinyl copolymer is preferably a block copolymer or a graft copolymer.

The ion-exchange membrane of the present invention may contain one kind of polymer, or a combination of two or more kinds of polymers. In one preferred embodiment of the present invention, the ion-exchange membrane of the present invention contains a polymer having an ionic group and a polymer having polyvinyl alcohol units, or contains a polymer having an ionic group and polyvinyl alcohol units. Crosslinking may be introduced into the polymer contained in the ion-exchange membrane.

The ion-exchange membrane of the present invention may also be used in an embodiment comprising a reinforcing material. Examples of the reinforcing material include, a continuous support comprising, for example, a porous membrane, a mesh or a nonwoven fabric. The nonwoven fabric may be a wet-type nonwoven fabric made of polyvinyl alcohol-based staple fibers.

[Production of Ion-Exchange Membrane]

The ion-exchange membrane of the present invention can be produced, for example, by heat-treating a polyvinyl alcohol-based polymer P (hereinafter sometimes simply referred to as a polymer P) or a composition containing the polymer. The present invention also relates to a method for producing an ion-exchange membrane, comprising heat-treating a composition containing a polymer P having polyvinyl alcohol units.

Examples of the polyvinyl alcohol-based polymer P or the composition containing the polymer include, for example, a polymer composition containing a polymer P1 having polyvinyl alcohol units and a polymer P2 having an ionic group, a polymer 3 having polyvinyl alcohol units and an ionic group, a composition containing these, and the like.

Examples of the polymer P1 having the polyvinyl alcohol units used for producing the ion-exchange membrane of the present invention include, for example, a polyvinyl alcohol homopolymer.

Examples of the polymer P1 having the polyvinyl alcohol units preferably include a polymer shown by the following general formula (P1):

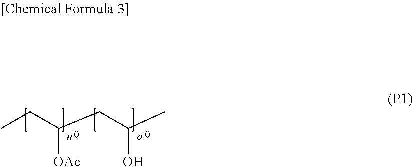

wherein 0.5000≦o⁰/(n⁰+o⁰)≦0.9999.

Examples of the polymer P2 having the ionic group used for producing the ion-exchange membrane of the present invention include, for example, a monomeric homopolymer consisting of an anionic group or a cationic group and at least one ethylenically unsaturated monomer.

Examples of the polymer P2 having the ionic group preferably include a polymer shown by the following general formula (P2):

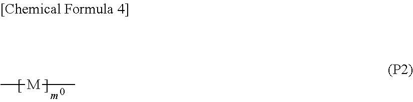

wherein M is a structural unit derived from a monomer M′ having an anionic group or a cationic group.

Examples of the polymer P3 having the polyvinyl alcohol units and the ionic group used for producing the ion-exchange membrane of the present invention include, for example, a polyvinyl alcohol-based copolymer. Examples of the polyvinyl alcohol-based copolymer include a block copolymer and a graft copolymer.

Examples of the polymer P3 having the polyvinyl alcohol units and the ionic group preferably include a block copolymer (BP) shown by the following general formula (1):

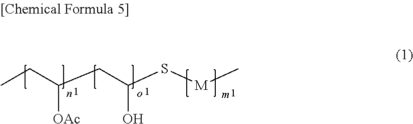

wherein 0.5000≦o¹/(n¹+o¹)≦0.9999; and
0.01≦m¹/(m¹+n¹+o¹)≦0.50; M is a structural unit derived from a monomer M′ having an anionic group or a cationic group, or a graft copolymer (GP) shown by the following general formula (2):

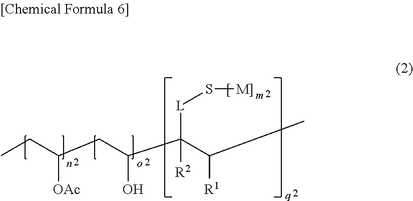

wherein 0.5000≦o²/(n²+o²)≦0.9999; 0.001≦q²/(n²+o²+q²)≦0.05; and 0.01≦q²m²/(q²m²+n²+o²)≦0.50; R¹ is a hydrogen atom or a carboxyl group; R² is a hydrogen atom, a methyl group, a carboxyl group or a carboxymethyl group. L is a divalent aliphatic hydrocarbon group having 1 to 20 carbon atoms optionally containing a nitrogen atom and/or an oxygen atom; when R¹ is a carboxyl group or when R² is a carboxyl group or a carboxymethyl group, R¹ and R² may each form a ring (cyclic structure) with an adjacent hydroxyl group (namely, a hydroxyl group contained in an adjacent structural unit); M is a structural unit derived from a monomer M′ having an anionic group or a cationic group.

Symbols in the general formulas (P1), (P2), (1) and (2) will be described.)

o⁰/(n⁰+o⁰) in the general formula (P1) shows the ratio of vinyl alcohol units contained in the polymer P1 having the polyvinyl alcohol units. A lower limit of the o⁰/(n⁰+o⁰) is preferably 0.5000 or more, more preferably 0.7000 or more, and even more preferably 0.8000 or more. An upper limit of the o⁰/(n⁰+o⁰) is preferably 0.9999 or less, preferably 0.999 or less, and even more preferably 0.995 or less. The o⁰/(n⁰+o⁰) within the above range is preferred from the viewpoint of easiness in production.

M in the above general formula (P2) is a structural unit derived from a monomer (hereinafter sometimes also referred to as a “monomer M′”) having an anionic group or a cationic group.

Examples of the monomer M′ include a monomer consisting of at least one anionic group or cationic group, and at least one ethylenically unsaturated monomer. Examples of the anionic group and the cationic group in the monomer M′ include the anionic groups and the cationic groups described above regarding the copolymer.

Examples of the ethylenically unsaturated monomer in the monomer M′ include, for example, α-olefins such as ethylene, propylene, n-butene and isobutyrene; styrenes such as styrene and α-methylstyrene; acrylic acid or its esters such as acrylic acid, methyl acrylate, ethyl acrylate, n-propyl acrylate, i-propyl acrylate, n-butyl acrylate, i-butyl acrylate and t-butyl acrylate; methacrylic acid and its esters such as methacrylic acid, methyl methacrylate, ethyl methacrylate, n-propyl methacrylate, i-propyl methacrylate, n-butyl methacrylate, i-butyl methacrylate, and t-butyl methacrylate; acrylamides such as acrylamide, N-methylacrylamide, N-ethylacrylamide, N,N-dimethylacrylamide and diacetoneacrylamide; methacrylamides such as methacrylamide, N-methylmethacrylamide, N-ethylmethacrylamide and methacrylamide propyldimethylamine; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether and 2,3-diacetoxy-1-vinyloxypropane; allyl compounds such as allyl acetate, 2,3-diacetoxy-1-allyloxypropane and allyl chloride; unsaturated dicarboxylic acids such as maleic acid, itaconic acid and fumaric acid and their esters, and the like.

Examples of the monomer M consisting of the anionic group and the ethylenically unsaturated monomer include, for example, compounds shown by the following general formulas (3)-(9).

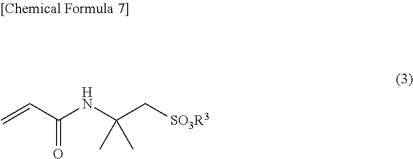

wherein R³ is a hydrogen atom or an alkali metal atom.

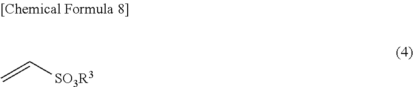

wherein R³ is as defined above.

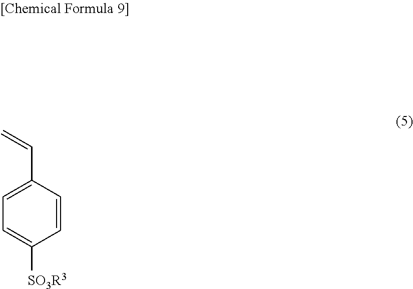

wherein R³ is as defined above.

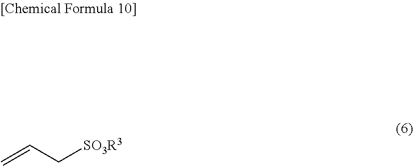

wherein R³ is as defined above.

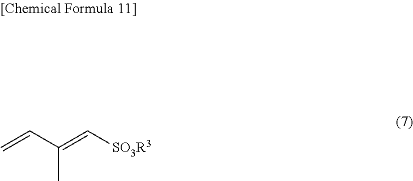

wherein R³ is as defined above.

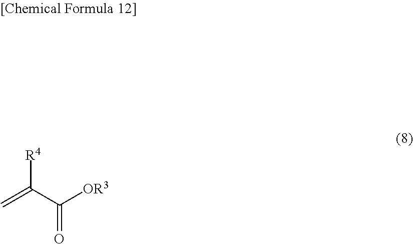

wherein R³ is as defined above, and R⁴ is a hydrogen atom or a methyl group.

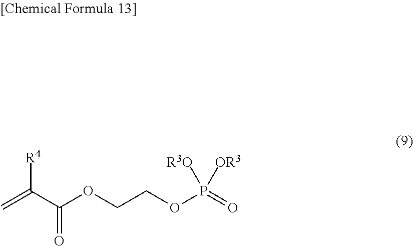

wherein R³ and R⁴ are as defined above.

Examples of the monomer M consisting of the cationic group and the ethylenically unsaturated monomer include, for example, compounds shown by the following general formulas (10)-(19).

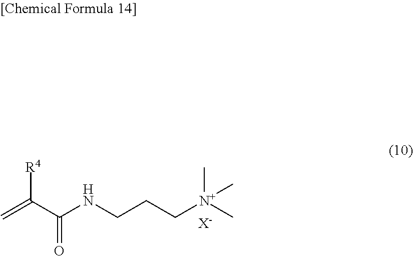

wherein X⁻ is a halogenated anion of a group 5B element, such as PF₆⁻, SbF₆⁻, or AsF₆⁻, a halogenated anion of a group 3B element such as BF₄⁻, a halogen anion such as I⁻(I₃⁻), Br⁻ or Cl⁻, a halogen acid anion such as ClO₄⁻, a metal halide anion such as AlCl₄⁻, FeCl₄⁻ or SnCl₅⁻, a nitrate anion denoted by NO₃⁻, an organic sulfonate anion such as p-toluene sulfonate anion, a naphthalene sulfonate anion, CH₃SO₃⁻ or CF₃SO₃⁻, a carboxylate anion such as CF₃COO⁻ or C₆H₅COO⁻, or a monovalent anion such as OH⁻, and R₄ is as defined above.

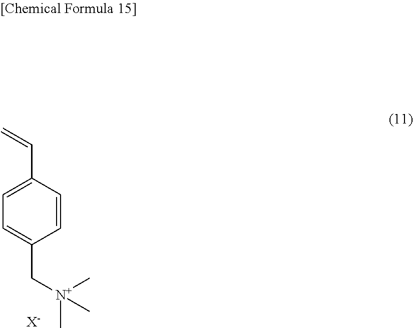

wherein X⁻ is as defined above.

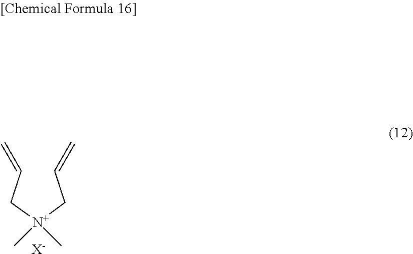

wherein X⁻ is as defined above.

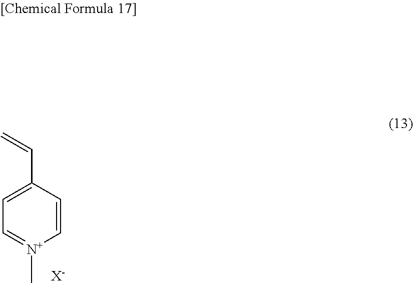

wherein X⁻ is as defined above.

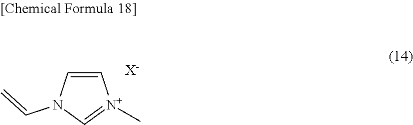

wherein X⁻ is as defined above.

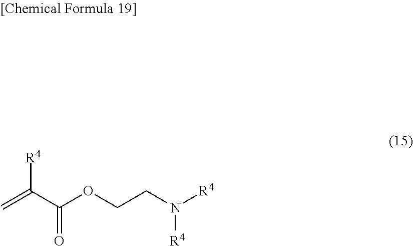

wherein R⁴ is as defined above, and they may be the same as or different from each other.

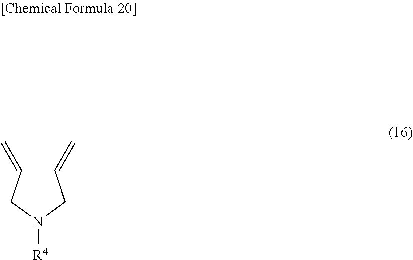

wherein R₄ is as defined above.

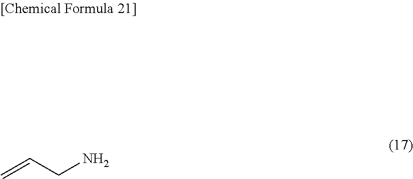

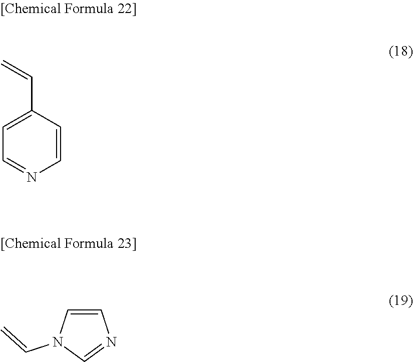

o¹/(n¹+o¹) in the above general formula (1) shows the ratio of vinyl alcohol units to a total of vinyl alcohol units and vinyl acetate units. A lower limit of the o¹/(n¹+o¹) is preferably 0.5000 or more, more preferably 0.7000 or more, and even more preferably 0.8000 or more. An upper limit of the o¹/(n¹+o¹) is preferably 0.9999 or less, more preferably 0.999 or less, and even more preferably 0.995 or less. The o¹/(n¹+o¹) within the above range is preferred from the viewpoint of easiness in production.

m¹/(m¹+n¹+o¹) in the general formula (1) shows the ratio of a polymer component having an anionic group or a cationic group in the copolymer. A lower limit of the m¹/(m¹+n¹+o¹) is preferably 0.01 or more, more preferably 0.03 or more, and even more preferably 0.05 or more. An upper limit of the m¹/(m¹+n¹+o¹) is preferably 0.50 or less, more preferably 0.30 or less, and even more preferably 0.25 or less.

M in the general formula (1) is synonymous with M described regarding the general formula (P2).

o²/(n²+o²) in the general formula (2) shows the ratio of vinyl alcohol units contained in a vinyl alcohol-based polymer component of the copolymer. A lower limit of the o²/(n²+o²) is preferably 0.5000 or more, more preferably 0.7000 or more, and even more preferably 0.8000 or more. An upper limit of the o²/(n²+o²) is preferably 0.9999 or less, more preferably 0.999 or less, and even more preferably 0.995 or less. The o²/(n²+o²) within the above range is preferred from the viewpoint of easiness in production.

q²/(n²+o²+q²) in the general formula (2) shows the molar fraction of branched units contained in the graft copolymer (GP). A lower limit of the q²/(n²+o²+q²) is preferably 0.001 or more, more preferably 0.002 or more, and even more preferably 0.003 or more. An upper limit of the q²/(n²+o²+q²) is preferably 0.05 or less, more preferably 0.02 or less, and even more preferably 0.01 or less. The q²/(n²+o²+q²) within the above range is preferred from the viewpoint that the copolymerization reaction is easily controlled.

q²m²/(q²m²+n²+o²) in the general formula (2) shows the ratio of a polymer component having an anionic group or a cationic group contained in a vinyl alcohol-based polymer component and a polymer component having an anionic group or a cationic group of the copolymer. A lower limit of the q²m²/(q²m²+n²+o²) is preferably 0.01 or more, more preferably 0.03 or more, and even more preferably 0.05 or more. An upper limit of the q²m²/(q²m²+n²+o²) is preferably 0.50 or less, more preferably 0.30 or less, and even more preferably 0.25 or less. The q²m²/(q²m²+n²+o²) which is the above upper limit or less is preferred since swelling of the ion-exchange membrane is favorably suppressed. When it is the lower limit or more, it is preferred since ion conductivity is favorable, and ion exchange performance is easily enhanced.

M in the general formula (2) is synonymous with M described regarding the general formula (P2).

L in the general formula (2) is a divalent aliphatic hydrocarbon group having 1 to 20 carbon atoms optionally containing a nitrogen atom and/or an oxygen atom. The number of nitrogen atoms and/or oxygen atoms contained in L is not particularly limited. The aliphatic hydrocarbon group may be any of linear, branched and cyclic, preferably linear or branched. When the aliphatic hydrocarbon group is branched, the number of carbon atoms of a moiety branched from a main chain (a chain of consecutive atoms between a sulfur atom and a nitrogen atom) is preferably 1-5. As examples in which L contains a nitrogen atom and/or an oxygen atom, for example, there are cases in which the aliphatic hydrocarbon group contains the nitrogen atom and/or the oxygen atom as a carbonyl bond (—CO—), an ether bond (—O—), an amino bond [—NR— (wherein R is a hydrogen atom or a group containing a carbon bound to N)], an amide bond (—CONH—) or the like, which is inserted into the aliphatic hydrocarbon group, and cases in which the aliphatic hydrocarbon group contains a nitrogen atom and/or an oxygen atom as a carboxyl group (—COOH), a hydroxyl group (—OH) or the like, which replaces the aliphatic hydrocarbon group. In view of availability of raw materials, and easiness in synthesis, L is preferably a linear or branched alkylene group optionally containing a carboxyl group in which the total number of carbon atoms is 1-20, more preferably a linear or branched alkylene group optionally containing a carboxyl group in which the total number carbon atoms is 2-15, and even more preferably a linear or branched alkylene group optionally containing a carboxyl group in which the total number carbon atoms is 2-10.

R¹ in the general formula (2) is a hydrogen atom or a carboxyl group, and R² is a hydrogen atom, a methyl group, a carboxyl group or a carboxymethyl group. R¹ and R² are each independently selected.

n⁰, n¹, n², o⁰, o¹, o², m⁰, m¹, m² and q² in the general formulas (P1), (P2), (1) and (2) represent the numbers of respective repeating units, and each independently, may be preferably 1-10000, more preferably 5-9000, and even more preferably 10-8000. The general formulas (P1), (P2), (1) and (2) do not mean that the repeating units in brackets are arranged as indicated, but show that each repeating unit is simply present. Although the repeating units are usually randomly arranged, the same repeating units may also be consecutively arranged.

A composition containing a polymer P1 having polyvinyl alcohol units and a polymer P2 having an ionic group, which can be used for producing the ion-exchange membrane of the present invention, can be produced, for example, by carrying out anionic polymerization, radical polymerization, cationic polymerization, coordination polymerization or the like using a polymeric monomer. Furthermore, when the polymer is a copolymer, the ion-exchange membrane of the present invention can be produced by carrying out copolymerization using another polymeric monomer together with said polymeric monomer.

The polymer P3 having the polyvinyl alcohol units and the ionic group, which can be used for producing the ion-exchange membrane of the present invention, can be produced, for example, by

(1a) a method of producing a vinyl alcohol-based polymer, and then binding an ionic group to the vinyl alcohol-based polymer, or by

(1b) a method of polymerizing a vinyl alcohol-based polymer and at least one monomer having an ionic group.

As the method (1a), one or more hydroxyl group modifiers (for example, butyraldehyde sulfonic acid or its alkali metal salts, benzaldehyde sulfonic acid or its alkali metal salts, cationic ammonium aldehyde and the like) are reacted in the presence of a vinyl alcohol-based polymer so that the ionic group is introduced into the vinyl alcohol-based polymer, thereby producing a copolymer. This is preferred in view of industrial easiness.

As the method (1b), at least one monomer containing an ionic group is subjected to radical polymerization in the presence of a vinyl alcohol-based polymer containing a mercapto group to produce a copolymer, which is preferred in view of industrial easiness. Since the kind and amount of each component can be easily controlled, the method (1b) is more preferred.

For example, a block copolymer (BP) can be produced using, for example, a terminal mercapto group-containing vinyl alcohol-based polymer, and a monomer having an ionic group by the polymerization method described in Patent Document 3 or Patent Document 4.

The content of vinyl alcohol units in the terminal mercapto group-containing vinyl alcohol-based polymer (namely, the saponification degree of the terminal mercapto group-containing vinyl alcohol-based polymer) is not particularly limited, but preferably 50 mol % or more, more preferably 70 mol % or more, and even more preferably 80 mol % or more, with a total of structural units in the polymer as 100 mol %. An upper limit of the content of vinyl alcohol units is preferably 99.99 mol % or less, more preferably 99.9 mol % or less, and even more preferably 99.5 mol % or less, with the total of the structural units in the polymer as 100 mol %.

The viscosity-average polymerization degree of the terminal mercapto group-containing vinyl alcohol-based polymer measured in accordance with JIS K6726 is not particularly limited, preferably 100-5,000, and more preferably 200-4,000. The viscosity-average polymerization degree which is the lower limit or more of the above is preferred from the viewpoint of the mechanical strength of a copolymer derived. The viscosity-average polymerization degree which is the upper limit or less of the above described is preferred since the vinyl alcohol-based polymer is industrially easily produced.

For example, a graft copolymer (GP) can be produced using a side chain mercapto group-containing vinyl alcohol-based polymer shown by general formula (21):

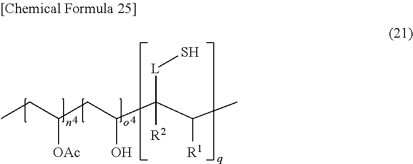

wherein n⁴, o⁴, q, L, R¹ and R² are as defined above, consisting of a structural unit shown by general formula (20):

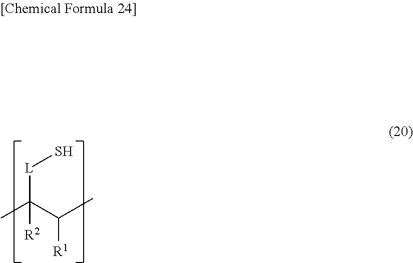

wherein R¹, R² and L are as defined above,
a vinyl alcohol-based structural unit, and
a monomer (M) having an ionic group, for example, by the polymerization method described in Patent Document 3 or Patent Document 4.

The structural unit shown by the general formula (20) can be derived from an unsaturated monomer that can be converted to said structural unit, preferably from a thioester-based monomer having unsaturated double bonds shown by general formula (22):

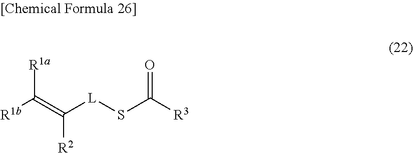

wherein R^{1a} and R^{1b} are a hydrogen atom or a carboxyl group, provided that at least one of R^{1a} and R^{1b} is the hydrogen atom; R³ is a methyl group, or covalently bonded to a specific carbon atom contained in L to form a cyclic structure; and R² and L are as defined above.

The thioester-based monomer having unsaturated double bonds shown by the general formula (22) can be produced in accordance with a publicly known method.

Preferred examples of the thioester-based monomer having unsaturated double bonds shown by the general formula (22) include, for example, thioacetic acid S-(3-methyl-3-buten-1-yl) ester, thioacetic acid S-17-octadecen-1-yl ester, thioacetic acid S-15-hexadecen-1-yl ester, thioacetic acid S-14-pentadecen-1-yl ester, thioacetic acid S-13-tetradecen-1-yl ester, thioacetic acid S-12-tridecen-1-yl ester, thioacetic acid S-11-dodecen-1-yl ester, thioacetic acid S-10-undecen-1-yl ester, thioacetic acid S-9-decen-1-yl ester, thioacetic acid S-8-nonen-1-yl ester, thioacetic acid S-7-octen-1-yl ester, thioacetic acid S-6-hepten-1-yl ester, thioacetic acid S-5-hexen-1-yl ester, thioacetic acid S-4-penten-1-yl ester, thioacetic acid S-3-buten-1-yl ester, thioacetic acid S-2-propen-1-yl ester, thioacetic acid S-[1-(2-propen-1-yl)hexyl] ester, thioacetic acid S-(2,3-dimethyl-3-buten-1-yl) ester, thioacetic acid S-(1-ethenylbuty) ester, thioacetic acid S-(2-hydroxy-5-hexen-1-yl) ester, thioacetic acid S-(2-hydroxy-3-buten-1-yl) ester, thioacetic acid S-(1,1-dimethyl-2-propen-1-yl) ester, 2-[(acetylthio)methyl]-4-pentenoic acid, thioacetic acid S-(2-methyl-2-propen-1-yl) ester, and the like, as well as compounds shown by the following chemical formulas (a-1)-(a-30).

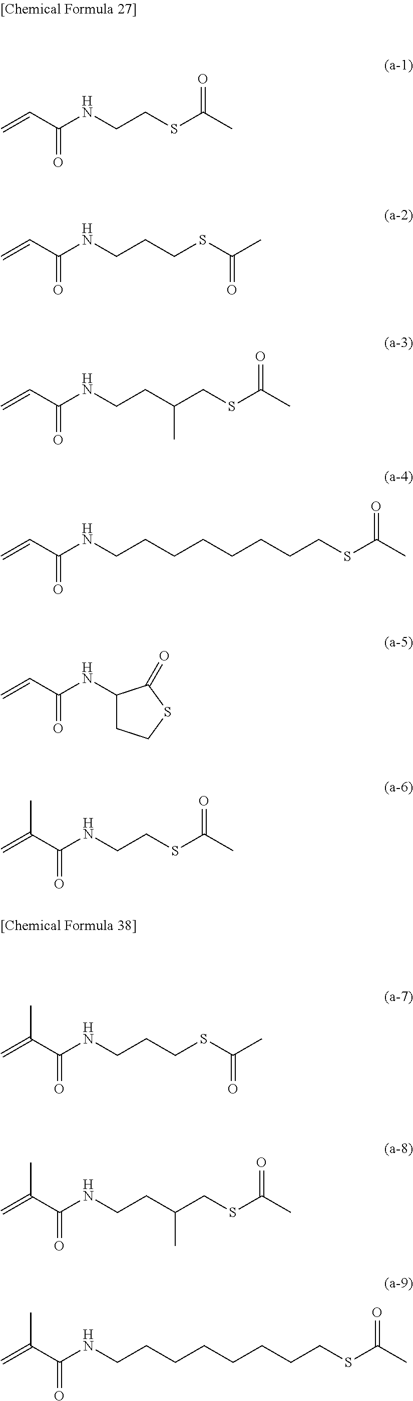

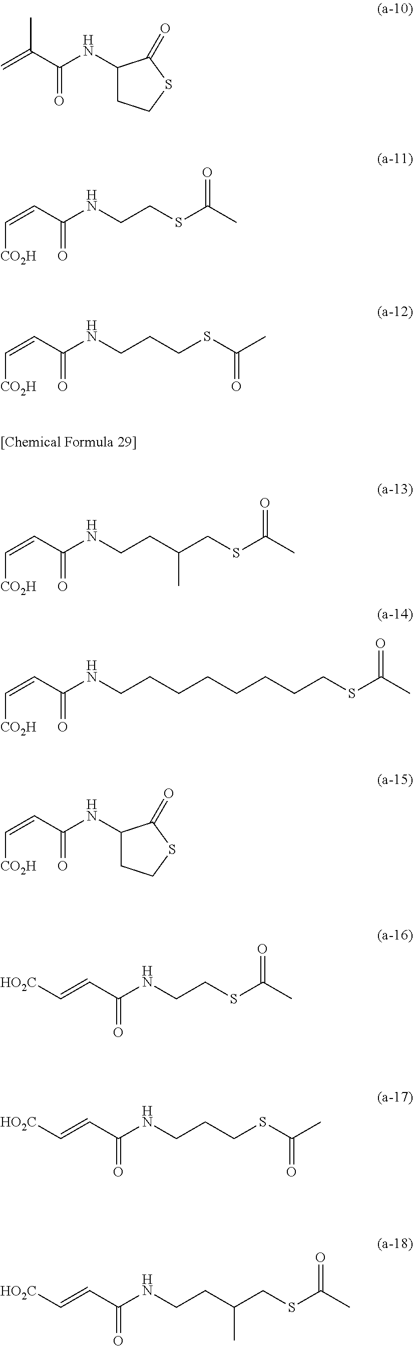

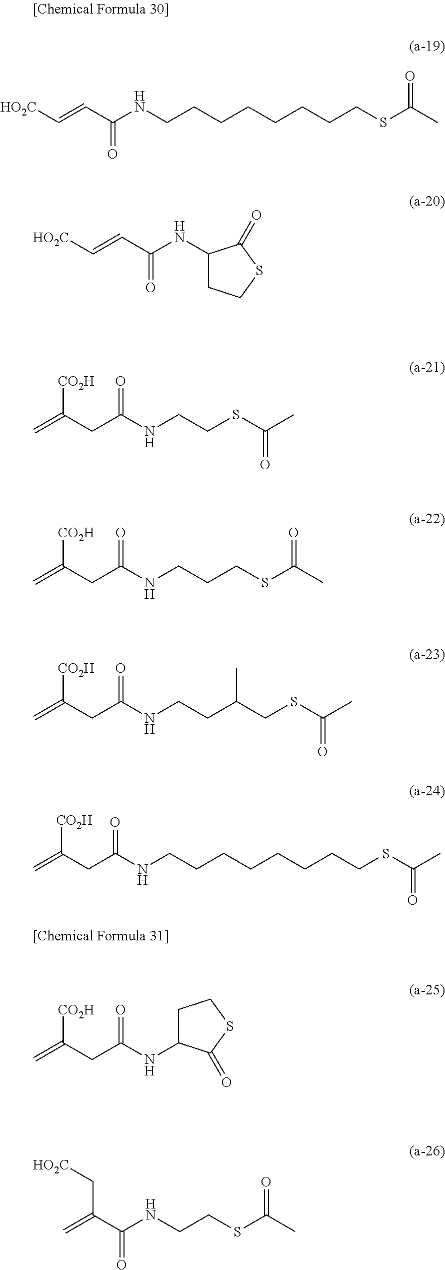

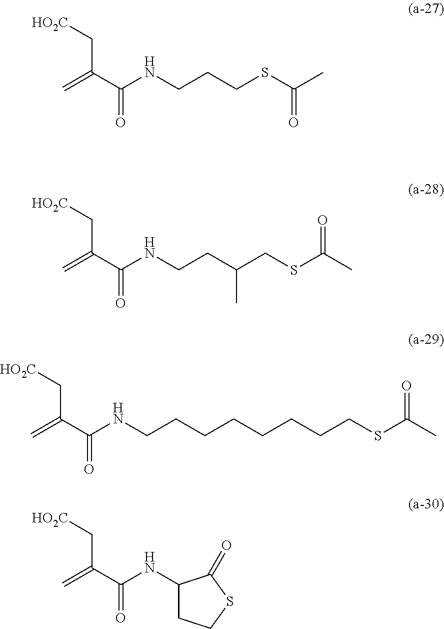

Among the group of compounds, from the viewpoints of availability of raw materials, and easiness in synthesis, thioacetic acid S-7-octen-1-yl ester, and compounds shown by the chemical formulas (a-6), (a-7), (a-9), (a-10), (a-11), (a-12), (a-14), (a-15), (a-16), (a-17), (a-19), (a-20), (a-21), (a-22), (a-24), (a-25), (a-26), (a-27), (a-29), (a-30) are preferred.

The content of structural units shown by the general formula (20) in the side chain mercapto group-containing vinyl alcohol-based polymer shown by the general formula (21) is not particularly limited, but preferably 0.1-5 mol %, more preferably 0.2-2 mol %, and even more preferably 0.3-1 mol %, with a total of structural units in the polymer as 100 mol %.

The side chain mercapto group-containing vinyl alcohol-based polymer shown by the general formula (21) may have one or two or more kinds of structural units shown by the formula (20). When it has two or more kinds of the structural units, the total content of these two or more kinds of structural units is preferably within the above range.

The content of vinyl alcohol units (namely, the saponification degree of the side chain mercapto group-containing vinyl alcohol-based polymer) is not particularly limited, but preferably 50 mol % or more, more preferably 70 mol % or more, and even more preferably 80 mol % or more, with the total of the structural units in the polymer as 100 mol %. An upper limit of the content of vinyl alcohol units is preferably 99.99 mol % or less, more preferably 99.9 mol % or less, and even more preferably 99.5 mol % or less, with the total of the structural units in the polymer as 100 mol %.

The vinyl alcohol units in the side chain mercapto group-containing vinyl alcohol-based polymer shown by the general formula (21) can be derived from vinyl ester units by hydrolysis, alcohol decomposition or the like. Vinyl esters of the vinyl ester units converted to vinyl alcohol units are not particularly limited, but vinyl acetate is preferred from an industrial perspective.

The side chain mercapto group-containing vinyl alcohol-based polymer shown by the general formula (21) may further contain a structural unit shown by the formula (20), a structural unit other than the vinyl alcohol unit and the vinyl ester unit as long as the effect of the present invention is obtained. Said structural unit includes, for example, an unsaturated monomer capable of copolymerizing with a vinyl ester and of being converted to the structural unit shown by the general formula (20), and a structural unit derived from an ethylenically unsaturated monomer capable of copolymerizing with a vinyl ester. The ethylenically unsaturated monomer is synonymous with the ethylenically unsaturated monomer descried regarding the monomer M′.

The order of arrangement of the structural unit shown by the general formula (20), the vinyl alcohol unit, and the other optional structural unit in the side chain mercapto group-containing vinyl alcohol-based polymer shown by the general formula (21) is not particularly limited, and may be any of random, block and alternate.

The viscosity-average polymerization degree of the side chain mercapto group-containing vinyl alcohol-based polymer shown by the general formula (21) measured in accordance with JIS K6726 is not particularly limited, preferably 100-5,000, and more preferably 200-4,000. The viscosity-average polymerization degree which is the lower limit or more is preferred from the viewpoint of the mechanical strength of the derived copolymer. The viscosity-average polymerization degree which is the upper limit or less is preferred since the vinyl alcohol-based polymer is industrially easily produced.

A method for producing a side chain mercapto group-containing vinyl alcohol-based polymer shown by the general formula (21) is not particularly limited as long as the intended side chain mercapto group-containing vinyl alcohol-based polymer can be produced. Examples of such a production method include a method comprising a copolymerization step of copolymerizing a vinyl ester and an unsaturated monomer which is capable of copolymerizing with the vinyl ester, and capable of being converted to a structural unit shown by the general formula (20), and a conversion step of converting vinyl ester units of the obtained copolymer to vinyl alcohol units by solvolysis, while on the other hand, converting structural units derived from the unsaturated monomer capable of being converted to structural units shown by the general formula (20) to the structural units shown by the general formula (20).

In particular, a method in which a vinyl ester and a thioester-based monomer shown by the general formula (22) having unsaturated double bonds (hereinafter referred to as a “thioester-based monomer (22)”) are copolymerized, and ester bonds of vinyl ester units and thioester bonds that are structural units derived from the thioester-based monomer (22) of the obtained copolymer are hydrolyzed or alcoholized to be converted to vinyl alcohol units and structural units shown by the general formula (20) respectively is simple and preferably used.

In the preferred method for producing the polymer shown by the general formula (21), copolymerization of the vinyl ester and the thioester-based monomer (22) can be carried out by adopting the publicly known method and conditions during homopolymerization of vinyl esters. During the copolymerization, a monomer copolymerizable with the vinyl ester and the thioester-based monomer may further be copolymerized. Said copolymerizable monomer is similar to the ethylenically unsaturated monomers described regarding the monomer M′.

Ester bonds of vinyl ester units and thioester bonds that are structural units derived from the thioester-based monomer (22) of the obtained copolymer can be hydrolyzed or alcoholized under almost the same conditions. Therefore, the ester bonds of the vinyl ester units and the thioester bonds of the structural units derived from the thioester-based monomer (22) of the obtained copolymer can be carried out by adopting a publicly known method and conditions during saponification of a vinyl ester homopolymer.

A desired shape can be imparted to the composition containing the thus obtained polymer P having polyvinyl alcohol units to prepare a membrane-like formed body. The copolymerization configuration when preparing a membrane-like formed body is not particularly limited, but the membrane-like formed body is preferably prepared using a solution containing the polymer P from a processability perspective. A solvent is not particularly limited, and examples thereof include polar solvents such as water, methanol, ethanol, isopropanol, diethyl ether, tetrahydrofuran, 1,4-dioxane, acetone, methyl ethyl ketone, N-methylpyrrolidone, N,N-dimethylformamide, dimethylsulfoxide, methyl ethyl sulfoxide and diethyl sulfoxide, or mixed solvents of these. Using water as the solvent is preferred from the viewpoint of the solubility of the polymer P. The concentration of the solution is not particularly limited, but the amount of the polymer P is preferably 0.1-50 parts by mass, more preferably 5-30 parts by mass, based on 100 parts by mass of the above solvent.

In addition to the polymer P and the solvent, any additives may be added to the composition containing the polymer P as necessary, and the addition order may be selected as appropriate. The additives may be selected from the publicly known additives and the like as necessary, and examples thereof include, for example, metal fine particles, inorganic fine particles, inorganic salts, ultraviolet absorbers, antioxidants, deterioration preventing agents, dispersants, surfactants, polymerization inhibitors, thickeners, conductivity enhancers, surface modifiers, preservatives, mildew-proofing agents, antimicrobial agents, defoaming agents, plasticizers, and the like. One kind of them may be used alone, and two or more kinds may also be used in combination.

In addition to the polymer P and the solvent, polyvinyl alcohol may also be added to the composition containing the polymer P as necessary in order to improve the strength of the formed body. The viscosity-average polymerization degree of the polyvinyl alcohol is not particularly limited, preferably 500-8,000, and more preferably 1,000-7,000 when measured in accordance with JIS K6726.

The composition containing the polymer P preferably has a pH of less than 3.0, more preferably less than 2.0 from the viewpoint that the effect of the subsequent heat treatment is easily enhanced. A method for adjusting the pH of the composition containing the polymer P is not particularly limited. For example, the pH may be adjusted by adding an acidic compound such as sulfuric acid, hydrochloric acid, acetic acid or ammonium chloride, or a basic compound such as sodium hydroxide, potassium hydroxide, ammonia or sodium acetate to an intermediate solution, or may be adjusted using an ion-exchange resin such as anionic exchange resin or cationic exchange resin, or may be adjusted by an electrodialysis method.

A method for producing a membrane-like formed body by imparting the desired shape to the polymer P is not particularly limited. For example, a melt forming method in which a composition containing the polymer P is plasticized by heating so as to be formed (for example, an extrusion forming method, an injection forming method, an inflation forming method, a press forming method, a blow forming method), a solvent cast method in which a solution is cast in a membrane-like form, and formed in the membrane-like form after removing a solvent by drying. By these forming methods, a membrane-like formed body having the desired thickness, such as a film or a sheet, is obtained.

When the melt forming method is used, a thermoplastic resin may be optionally added to the composition containing the polymer P as necessary, and the order of addition may also be optionally selected. The thermoplastic resin is not particularly limited, and a general thermoplastic resin may be used.

When the solvent-cast method is used, a casting machine, a film applicator and the like may be used, however, it is not particularly limited to them. The film-like formed body may be laminated on a polymer film such as a polyethylene terephthalate film, a nylon film or polypropylene, on a metal foil such as a copper foil or an aluminum foil, or on an inorganic substrate such as a glass substrate or a silicon substrate. The film-like formed body may also have a multilayer structure. Furthermore, the film-like formed body may also be complexed to a porous material such as a porous film, a mesh, a nonwoven fabric, a porous ceramics or a zeolite, or alternatively may be formed on a surface of a formed body such as a three-dimensionally processed polymer, a metal, a ceramics or a glass.

The ion-exchange membrane of the present invention preferably has a membrane thickness of about 30-1000 μm, more preferably 40-500 μm, and even more preferably 50-300 μm from the viewpoints of performance, mechanical strength, handling properties and the like required as an electrolytic membrane for electrodialysis. The membrane thickness which is the lower limit or more is preferred from the viewpoint of the mechanical strength of the obtained membrane. The membrane thickness which is the upper limit or less is preferred from the viewpoint that the membrane resistance is reduced and ion-exchange performance is easily enhanced. The membrane thickness can be measured by a micrometer.

When the desired shape is imparted to the composition containing the polymer P, the membrane-like formed body can also be reinforced by adding a reinforcing material composed of an inorganic material or an organic material, or of an organic-inorganic hybrid material. The reinforcing material may be a fibrous material, a granular material or a flake-like material. Furthermore, it may also be continuous supports such as a porous membrane, a mesh, and a nonwoven fabric. By adding the reinforcing material, the mechanical strength and dimensional stability of the resultant final ion-exchange membrane can further be improved. In particular, use of the fibrous material or the above-described continuous support as the reinforcing material makes it easy to improve the dynamic strength and dimensional stability of the resultant final ion-exchange membrane, which is preferred. Furthermore, a multilayer laminate in which a non-reinforced layer and a reinforced layer are laminated in multilayers by any method is also preferred.

When the reinforcing material is processed into the membrane-like formed body, the reinforcing material may be used by being added to and mixed with the composition containing the polymer P, or the reinforcing material may be impregnated with the composition containing the polymer P, or the reinforcing material and the membrane-like formed body after the membrane formation may be laminated.

The reinforcing material is preferably a continuous support composed of a porous film, a mesh or a nonwoven fabric, more preferably a nonwoven fabric from the viewpoints of strength and processability. As the nonwoven fabric, a wet type nonwoven fabric formed of staple fibers (fiber length: 1-30 mm) is preferred. A nonwoven fabric-forming polymer (or a constituent polymer of principal fibers) is not particularly limited, but for example, polyesters (PET, PTT and the like), polyvinyl alcohol and the like are given, and particularly preferably polyvinyl alcohol. Examples of the particularly preferred nonwoven fabric sheet include a wet-type nonwoven fabric composed of polyvinyl alcohol staple fibers as the principal fibers. Here, the nonwoven type fabric can be produced by dispersing principal fibers and a small amount of binder fibers for bonding between the principal fibers in water to form a slurry under mild stirring, forming this slurry into a sheet using a paper machine having at least one of wires such as a round net, a long net, and a slanted type.

In one embodiment of the present invention in which the nonwoven fabric is used as the reinforcing material, polyvinyl alcohol-based principal fibers which are insoluble in water at 90° C. or less, and have a saponification degree of 99.9 mol % or more are preferred. Furthermore, polyvinyl alcohol-based principal fibers which have been subjected to an acetalization treatment are also preferred. The acetalization degree is preferably 15-40 mol %, and more preferably 25-35 mol %. Polyvinyl alcohol constituting the polyvinyl alcohol-based principal fibers preferably has a polymerization degree of 1000-2500. Publicly known methods can be adopted as a method for producing the polyvinyl alcohol-based principal fibers. Any of a wet spinning method, a dry-wet spinning method, and a dry spinning method may be adopted. Since the polyvinyl alcohol-based principal fibers are used as the wet-type nonwoven fabric in this embodiment, their fineness is preferably 0.3-10 dtex, and more preferably 0.5-5 dtex.

The inorganic material used as the reinforcing material is not particularly limited as long as it has a reinforcing effect, and examples thereof include glass fiber, carbon fiber, cellulose fiber, kaoline clay, kaolinite, halloysite, pyrophyllite, talc, montmorillonite, sericite, mica, amesite, bentonite, asbestos, zeolite, calcium carbonate, calcium silicate, diatom earth, quartz sand, ferrous ferrite, aluminum hydroxide, aluminum oxide, magnesium oxide, titanium oxide, zirconium oxide, graphite, fullerene, carbon nanotubes, carbon nanohorns, and the like. The organic reinforcing material used as the reinforcing material is not also particularly limited as long as it has a reinforcing effect, and examples thereof include polyvinyl alcohol, polyphenylene sulfide, polyphenylene ether, polysulfone, polyether sulfone, polyether ether sulfone, polyether ketone, polyether ether ketone, polythioether sulfone, polythioether ether sulfone, polythioether ketone, polythioether ether ketone, polybenzimidazole, polybenzoxazole, polyoxadiazole, polybenzoxazinone, polyxylylene, polyphenylene, polythiophene, polypyrrole, polyaniline, polyacene, polycyanogene, polynaphthylidine, polyphenylenesulfide sulfone, polyphenylene sulfone, polyimide, polyetherimide, polyesterimide, polyamideimide, polyamide, aromatic polyamide, polystyrene, acrylonitrile-styrene resin, polystyrene-hydrogenated polybutadiene-polystyrene block copolymer, acrylonitrile-butadiene-styrene resin, polyester, polyarylate, liquid crystal polyester, polycarbonate, polytetrafluoroethylene, polyvinylidene fluoride, polyvinyl chloride, polyvinylidene chloride, vinylon fiber, methacrylic resin, epoxy resin, phenol resin, melamine resin, urethane resin, cellulose, polyketone, polyacetal, polypropyrene, polyethylene, and the like. The hybrid organic-inorganic material may also be used as the reinforcing material, and examples thereof include, for example, organic silicon polymer compounds having a silsesquioxane structure or a siloxane structure, such as POOS (Polyhedral Oligomeric Silsesquioxanes) or silicone rubber, and the like.

By heat treating the composition containing the thus obtained polymer P, an ion-exchange membrane satisfying the relationship shown by the formula (A) can be obtained. The heat treatment method may be selected as appropriate depending on the kind and shape of the membrane-like formed body, and a publicly known method can be generally used. The heat treatment can be performed using, for example, a hot-air dryer, a hot press, a hot plate, an infrared heater, a roller heater or the like. When a large-area heat treatment is performed, a planar heating means is preferable, and a hot press, a hot plate, an infrared heater, a roller heater and the like are more preferred. Conditions for the heat treatment are not particularly limited. The heat treatment may be performed in an inert atmosphere such as air or nitrogen, or under reduced pressure, at a heat treatment temperature of preferably 100-250° C., more preferably 140-200° C., and for a heating time of preferably 5 seconds to 4 hours, more preferably 1 minute to 2 hours. The heat treatment may be performed by being divided into a plurality of times.

Here, since a part of hydroxyl groups is converted to carbonyl groups by heat-treating the composition containing the polymer P, the thus produced ion-exchange membrane is considered to satisfy the relationship shown by the formula (A).

The ion-exchange membrane of the present invention may be subjected to crosslinking treatment if necessary. Introducing crosslinking bonds by subjecting it to the crosslinking treatment can easily improve electrodialytic performance even more, as well as can easily enhance the mechanical strength of the ion-exchange membrane even more, which is preferred. The crosslinking method may be a method as long as molecular chains of the polymer can be bound by chemical bonds, and is not particularly limited. Usually, a method in which the ion-exchange membrane is immersed in a solution containing a crosslinking agent and the like are used. Examples of the crosslinking agent include, for example, formaldehyde, or dialdehyde compounds such as glyoxal and glutaraldehyde.

Examples of the crosslinking method include a method in which the crosslinking agent is mixed in advance with a composition containing the polymer P before performing the heat treatment to produce a membrane-like formed body, which is then heat treated, and a method in which an ion-exchange membrane obtained after the heat treatment is immersed in a solution in which a dialdehyde compound is dissolved in water, an alcohol or a mixed solvent of these under acidic conditions, thereby performing crosslinking treatment. Considering the processability, it is preferred to perform the crosslinking treatment by the latter method. When the crosslinking treatment is performed by the latter method, usually, a solution in which the volume concentration of the crosslinking agent with respect to the solution is 0.001-10 vol % is used.

The ion-exchange membrane of the present invention has a membrane resistance of preferably 10 Ωcm² or less, more preferably 5 Ωcm² or less from a power cost perspective. The ion-exchange membrane may have a membrane resistance of 0 Ωcm² or more, and is usually about 0.1 Ωcm² or more.

### EXAMPLES

Examples are given hereinafter in order to explain the present invention in more detail, however, it should not be construed that the present invention is limited to these Examples.

[Parameter A]

Using a Fourier transform infrared spectrophotometer (“Nicolet iS10” manufactured by Thermofisher Scientific Co., Ltd.), an infrared spectrum of an ion-exchange membrane was measured by a transmission method.

From the obtained spectrum, the absorbance (X) at an absorption wavelength of 1690 cm⁻¹, the absorbance (Y) at an absorption wavelength of 1720 cm⁻¹, and the integral value (Z) for the region lying between the wavelengths of 1690 cm⁻¹ and 1720 cm⁻¹ was found. By substituting them into the following equation, parameter A was calculated. T is the thickness of the ion-exchange membrane (cm), which can be measured by a micrometer.

A={Z−(X+Y)×30/2}/T [Numerical Formula 3]

[Dynamic Transport Number]

The dynamic transport number of the ion-exchange membrane was measured as follows. An ion-exchange membrane is inserted in a two-chamber cell having two platinum black electrode plates shown in FIG. 2, both sides of the ion-exchange membrane were filled with a 0.5 mol/L-NaCl solution, and then electrodialysis was performed. Using ion chromatography, a change in the amount of ions before and after the dialysis was calculated, then the calculated value was substituted into the following equation to calculate a dynamic transport number t_{d}⁺.

t_{d}⁺=Δm/Ea [Numerical Formula 4]

t_{d}⁺: dynamic transport number

Ea: theoretical equivalent=I·t/F

Δm: transfer equivalent

F: Faraday constant

[Membrane Resistance]

The membrane resistance was measured as follows. An ion-exchange membrane was inserted in a two-chamber cell having platinum black electrode plates as shown in FIG. 3, both sides of the membrane were filled with a 0.5 mol/L-NaCl solution, and then the resistance between the electrodes at 25° C. was measured using an AC bridge (frequency: 1000 cycles/sec). The membrane resistance was found from a difference between the above interelectrode resistance and an interelectrode resistance in the absence of the ion-exchange membrane. The membranes used in the above measurement had been equilibrated in a 0.5 mol/L-NaCl solution.

### Synthesis Example 1: Synthesis of Terminal Mercapto Group-Containing Polyvinyl Alcohol (PVA-1)

Polyvinyl alcohol having a mercapto group at its terminal (PVA-1) was synthesized by the method described in JP S59-187003 A (Polyvinyl alcohol-based polymer having a mercapto group at its terminal and method for producing the same). The obtained PVA-1 had a viscosity-average polymerization degree measured in accordance with JIS K6726 of 1500 and a saponification degree of 99.9 mol %.

### Synthesis Example 2: Synthesis of Thioester-Based Monomer Modified Polyvinyl Acetate (Preliminary Step of Synthesis of Side Chain Mercapto Group-Containing Polyvinyl Alcohol)

In a reactor vessel equipped with a stirrer, a reflux condenser, an argon introduction tube, a comonomer addition port and a polymerization initiation addition port, 450 parts by mass of vinyl acetate, 0.64 parts by mass of a thioester-based monomer shown by the chemical formula (a-11), and 330 parts by mass of methanol were charged, and the system was subjected to argon replacement for 30 minutes while bubbling argon therethrough. Separately from this, a solution of a thioester-based monomer (a-11) in methanol (concentration: 4 mass %) was prepared as a comonomer solution for successive addition (hereinafter noted as a delay solution), and argon was bubbled for 30 minutes. The temperature elevation of the reactor was started. When the internal temperature reached 60° C., 0.1 part by mass of 2,2′-azobisisobutyronitrile was added to start polymerization. During proceeding of the polymerization reaction, the monomer composition (molar fractions of vinyl acetate and the thioester-based monomer (a-11)) in the polymerization solution was kept constant by dropping the prepared delay solution in the system. After polymerized at 60° C. for 210 minutes, the mixture was cooled to stop the polymerization. The polymerization rate when the polymerization was stopped was 40%. Next, an unreacted vinyl acetate monomer was distilled off while adding methanol under reduced pressure to obtain a solution of a modified polyvinyl acetate with the thioester-based monomer (a-11) introduced in methanol.

### Synthesis Example 3: Synthesis of Side Chain Mercapto Group-Containing Polyvinyl Alcohol (PVA-2)

To the solution of the modified polyvinyl acetate with the thioester based monomer (a-11) introduced in methanol obtained in Synthesis Example 2, methanol was added, and further a solution of sodium hydroxide in methanol (the concentration: 12.8%) was added thereto, and saponification was carried out at 40° C. (the concentration of polyvinyl acetate with the thioester-based monomer (a-11) introduced in the saponification solution: 30%; the molar ratio of sodium hydroxide to vinyl acetate units in the polyvinyl acetate with the thioester-based monomer (a-11) introduced: 0.040). Since a gelled product was produced about 8 minutes after the solution of sodium hydroxide in methanol was added, this was ground by a grinder, and further left to stand at 40° C. for 52 minutes so that saponification was allowed to proceed. To this was added methyl acetate to neutralize the remaining alkali, then the resultant product was washed well with methanol, and dried in a vacuum dryer at 40° C. for 12 hours to obtain side chain mercapto group-containing PVA (PVA-2). Furthermore, chemical shift values obtained by ¹H-NMR measurement are shown below. The content of structural units (modification amount) represented by formula (I):

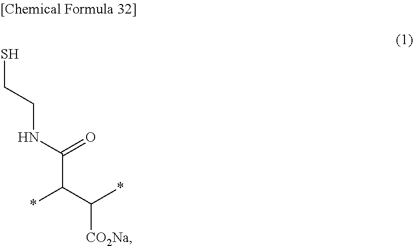

which was obtained by the ¹H-NMR measurement, was 1.0 mol %. Furthermore, the viscosity-average polymerization degree measured in accordance with JIS K6726 was 1000 and the saponification degree was 97.9 mol %.

¹H-NMR (270 MHz, D₂O (containing DSS), 60° C.)

δ (ppm): 1.3-1.9 (—CH₂CH(OH)—), 2.0-2.2 (—CH₂CH(OCOCH₃)—), 2.5-2.6 (CONHCH₂CH₂SH), 3.5-4.2 (—CH₂CH(OH)—, —CH(COOH)CH—, CONHCH₂CH₂SH)

### Synthesis Example 4: Aqueous Solution P-1 (Aqueous Solution of Block Copolymer PVA-b-PSS)

In a 300-mL four-necked separable flask equipped with a reflux condenser, and a stirring blade, 136 g of water, 25.0 g of PVA-1 as a polyvinyl alcohol having a mercapto group at its terminal, and 14.0 g of sodium p-styrenesulfonate (purity of 90%: manufactured by TOSOH ORGANIC CHEMICAL CO., LTD.) were charged. The mixture was heated to 90° C. under stirring, and dissolved while bubbling nitrogen. After replaced with nitrogen, 11.8 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 4 hours, followed by cooling to prepare an aqueous solution P-1 of a block copolymer of polyvinyl alcohol and sodium p-styrenesulfonate PVA-b-PSS. The aqueous solution had a pH of 7.0. A part of the aqueous solution P-1 was dried, then dissolved in heavy water, and then subjected to 500 MHz ¹H-MNR measurement. As a result, the modified amount of PSS units was 10 mol %.

### Synthesis Example 5: Aqueous Solution P-2 (Aqueous Solution of Block Copolymer PVA-b-PSS)

In a 300-mL four-necked separable flask equipped with a reflux condenser, and a stirring blade, 144 g of water, 25.0 g of PVA-1 as a polyvinyl alcohol having a mercapto group at its terminal, and 17.2 g of sodium p-styrenesulfonate (purity of 90%: manufactured by TOSOH ORGANIC CHEMICAL CO., LTD.) were charged. The mixture was heated to 90° C. under stirring, and dissolved while bubbling nitrogen. After replaced with nitrogen, 14.5 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 4 hours, followed by cooling to prepare an aqueous solution P-2 of a block copolymer of polyvinyl alcohol and sodium p-styrenesulfonate PVA-b-PSS. The aqueous solution had a pH of 7.0. A part of the aqueous solution P-10 was dried, then dissolved in heavy water, and then subjected to 500 MHz ¹H-MNR measurement. As a result, the modified amount of PSS units was 12 mol %.

### Synthesis Example 6: Aqueous Solution P-3 (Aqueous Solution of Graft Copolymer PVA-g-PSS)

In a 300-mL four-necked separable flask equipped with a reflux condenser, and a stirring blade, 136 g of water, 25.0 g of PVA-2 as a polyvinyl alcohol having a mercapto group at its side chain, and 14.0 g of sodium p-styrenesulfonate (purity of 90%: manufactured by TOSOH ORGANIC CHEMICAL CO., LTD.) were charged. The mixture was heated to 90° C. under stirring, and dissolved while bubbling nitrogen. After replaced with nitrogen, 11.8 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 4 hours, followed by cooling to prepare an aqueous solution P-3 of a graft copolymer of polyvinyl alcohol and sodium p-styrenesulfonate PVA-g-PSS. The aqueous solution had a pH of 7.0. A part of the aqueous solution P-3 was dried, then dissolved in heavy water, and then subjected to 500 MHz ¹H-MNR measurement. As a result, the modified amount of PSS units was 10 mol %.

### Synthesis Example 7: Aqueous Solution P-4 (Blended Aqueous Solution of PVA and PSS)

In a 300-mL four-necked separable flask equipped with a reflux condenser, and a stirring blade, 136 g of water, 25.0 g of polyvinyl alcohol (“PVA-117” manufactured by KURARAY CO., LTD.), and 14.0 g of sodium p-styrenesulfonate (purity of 90%: manufactured by TOSOH ORGANIC CHEMICAL CO., LTD.) were charged. The mixture was heated to 90° C. under stirring, and dissolved while bubbling nitrogen. After replaced with nitrogen, 11.8 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 4 hours, followed by cooling to prepare a mixed aqueous solution P-4 of polyvinyl alcohol and sodium polystyrenesulfonate. The aqueous solution had a pH of 7.0.

### Synthesis Example 8: Aqueous Solution P-5 (Aqueous Solution of Block Copolymer PVA-b-AMPS)

In a 500-mL four-necked separable flask equipped with a reflux condenser, and a stirring blade, 136 g of water, 25.0 g of a terminal mercapto group-containing polyvinyl alcohol (PVA-1), and 13.1 g of 2-acrylamide-2-methylpropanesulfonic acid (AMPS) were charged. The mixture was heated to 90° C. under stirring, and dissolved while bubbling nitrogen. After replaced with nitrogen, 11.9 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 4 hours, followed by cooling to prepare an aqueous solution P-5 of a block copolymer of polyvinyl alcohol and 2-acrylamide-2-methylpropanesulfonic acid PVA-b-AMPS. The aqueous solution had a pH of 0.9. A part of the aqueous solution P-5 was dried, then dissolved in heavy water, and then subjected to 500 MHz ¹H-MNR measurement. As a result, the modified amount of AMPS units was 10 mol %.

### Synthesis Example 9: Aqueous Solution P-6 (Aqueous Solution of Block Copolymer PVA-b-VBTAC)

In a 500-mL four-necked separable flask equipped with a reflux condenser, and a stirring blade, 137 g of water, 25.0 g of a terminal mercapto group-containing polyvinyl alcohol (PVA-1), and 13.4 g of vinylbenzyltrimethylammonium chloride (VBTAC) were charged. The mixture was heated to 90° C. under stirring, and dissolved while bubbling nitrogen. After replaced with nitrogen, 12.2 mL of a 2.0% aqueous solution of 2,2′-azobis[2-methyl-N-(2-hydroxyetyl)-2-propionamide] was gradually added to the above aqueous solution over 1.5 hours, so that polymerization was started and allowed to proceed. Then, polymerization was further allowed to proceed while maintaining the temperature in the system at 90° C. for 24 hours, followed by cooling to prepare an aqueous solution P-6 of a block copolymer of polyvinyl alcohol and vinylbenzyltrimethylammonium chloride PVA-b-VBTAC. The aqueous solution had a pH of 8.0. A part of the aqueous solution P-6 was dried, then dissolved in heavy water, and then subjected to 500 MHz ¹H-MNR measurement. As a result, the modified amount of VBTAC units was 10 mol %.

### Example 1

To 100 g of the aqueous solution P-1 obtained in Synthesis Example 4, 3.61 g of 47% sulfuric acid was added, and the mixture was applied to a PET film using an applicator bar with a gap of 850 μm. A vinylon nonwoven fabric BNF No. 2 (manufactured by KURARAY CO., LTD.) was bonded thereonto, followed by drying at 80° C. for 30 minutes using a hot-air dryer. Thereafter, the PET film was peeled off, and the resultant product was subjected to heat treatment under the condition of 150° C. for 30 minutes in a high temperature heat treatment apparatus to obtain an ion-exchange membrane Q-1.

### Example 2

The same operation was performed as in Example 1 except that the amount of sulfuric acid added was changed to 2.59 g to obtain an ion-exchange membrane Q-2.

### Example 3

The same operation was performed as in Example 1 except that the amount of sulfuric acid added was changed to 1.57 g to obtain an ion-exchange membrane Q-3.

### Example 4

The same operation was performed as in Example 1 except that the amount of sulfuric acid added was changed to 1.02 g to obtain an ion-exchange membrane Q-4.

### Example 5

The same operation was performed as in Example 1 except that the heat treatment condition in the high temperature heat treatment apparatus was changed to 130° C. for 30 minutes to obtain an ion-exchange membrane Q-5.

### Example 6

The same operation was performed as in Example 1 except that the aqueous solution P-2 obtained in Synthesis Example 5 was used in place of the aqueous solution P-1, and that the amount of sulfuric acid added was changed to 1.57 g to obtain an ion-exchange membrane Q-6.

### Example 7

The same operation was performed as in Example 1 except that the aqueous solution P-3 obtained in Synthesis Example 6 was used in place of the aqueous solution P-1, and that the amount of sulfuric acid added was changed to 1.57 g to obtain an ion-exchange membrane Q-7.

### Example 8

The same operation was performed as in Example 1 except that the aqueous solution P-4 obtained in Synthesis Example 7 was used in place of the aqueous solution P-1 to obtain an ion-exchange membrane Q-8.

### Example 9

The same operation was performed as in Example 1 except that the aqueous solution P-5 obtained in Synthesis Example 8 was used in place of the aqueous solution P-1, and that no sulfuric acid was added to obtain an ion exchange membrane Q-9.

### Example 10

The same operation was performed as in Example 1 except that the aqueous solution P-6 obtained in Synthesis Example 9 was used in place of the aqueous solution P-1 to obtain an ion-exchange membrane Q-10.

### Example 11

The same operation was performed as in Example 1 except that the aqueous solution P-6 obtained in Synthesis Example 9 was used in place of the aqueous solution P-1, and that the amount of sulfuric acid added was changed to 2.59 g to obtain an ion-exchange membrane Q-11.

### Example 12

The same operation was performed as in Example 1 except that the aqueous solution P-6 obtained in Synthesis Example 9 was used in place of the aqueous solution P-1, and the amount of sulfuric acid added was changed to 1.57 g to obtain an ion-exchange membrane Q-12.

### Example 13

The same operation was performed as in Example 1 except that the aqueous solution P-6 obtained in Synthesis Example 9 was used in place of the aqueous solution P-1, and that the amount of sulfuric acid added was changed to 1.02 g to obtain an ion-exchange membrane Q-13.

### Comparative Example 1

The same operation was performed as in Example 1 except that the heat treatment condition in the high-temperature heat treatment apparatus was changed to 110° C. for 30 minutes to obtain an ion-exchange membrane Q-14.

### Comparative Example 2

The same operation was performed as in Example 1 except that no sulfuric acid was added and that the heat treatment in the high-temperature heat treatment apparatus was not performed to obtain an ion-exchange membrane Q-15.

### Comparative Example 3

The same operation was performed as in Example 1 except that the aqueous solution P-6 obtained in Synthesis Example 9 was used in place of the aqueous solution P-1, that no sulfuric acid was added, and that the heat treatment in the high-temperature heat treatment apparatus was not performed to obtain an ion-exchange membrane Q-16.

[Evaluation]

The obtained ion-exchange membranes Q-1 to Q-16 were subjected to measurements of the parameter A, membrane resistance and dynamic transport number. The results are shown in Table 1.

TABLE 1

| | Ion- | | Membrane | Dynamic |
|---|---|---|---|---|
| | exchange | | resistance | transport |
| | membrane | Parameter A | (Ω · cm²) | number (%) |
| Example 1 | Q-1 | 690 | 14.4 | 99 |
| Example 2 | Q-2 | 483 | 8.1 | 99 |
| Example 3 | Q-3 | 411 | 5.7 | 99 |
| Example 4 | Q-4 | 299 | 4.0 | 99 |
| Example 5 | Q-5 | 171 | 3.4 | 98 |
| Example 6 | Q-6 | 304 | 3.5 | 99 |
| Example 7 | Q-7 | 415 | 5.5 | 99 |
| Example 8 | Q-8 | 389 | 7.1 | 99 |
| Example 9 | Q-9 | 401 | 4.1 | 99 |
| Example 10 | Q-10 | 114 | 3.6 | 97 |
| Example 11 | Q-11 | 61 | 3.9 | 97 |
| Example 12 | Q-12 | 92 | 4.7 | 97 |
| Example 13 | Q-13 | 112 | 4.8 | 97 |
| Comparative | Q-14 | −12 | 2.2 | 81 |
| Example 1 | | | | |
| Comparative | Q-15 | −23 | Unmeasurable | Unmeasurable |
| Example 2 | | | due to elution | due to elution |
| Comparative | Q-16 | −7 | Unmeasurable | Unmeasurable |
| Example 3 | | | due to elution | due to elution |

From Table 1, since ion-exchange membranes with the parameter A in the range of 30 or more have high water resistance, a low membrane resistance, and a high dynamic transport number, they also have high performance as ion-exchange membranes (Examples 1-13). On the other hand, the ion-exchange membrane of Comparative 1 with the parameter A not in the range of 30 or more had low membrane resistance, but did not have a sufficient dynamic transport number and thus did not have sufficient performance as an ion-exchange membrane. Furthermore, the ion exchange membranes of Comparative Examples 2 and 3 with parameter A not in the range of 30 or more had low water resistance, and they were eluted when measuring the membrane resistance or dynamic transport number. Thus it was impossible to measure them.

A: power source

B: ampere meter

C: coulomb meter

D: voltage meter

E: motor

F: stirrer

G: cathode electrode

H: anode electrode

I: 0.5 M NaCl aqueous solution

J: ion-exchange membrane (effective membrane area: 8.0 cm²)

K: ion-exchange membrane (effective membrane area: 1.0 cm²)

L: platinum electrode

M: NaCl aqueous solution

N: water bath

O: LCR meter

1. An ion-exchange membrane which gives an infrared absorption spectrum that satisfies the relationship shown by formula (A):
30≦{Z−(X+Y)×30/2}/T (A)
wherein
X is the absorbance at an absorption wavelength of 1690 cm⁻¹,
Y is the absorbance at an absorption wavelength of 1720 cm⁻¹,
Z is the integral value for the region lying between absorption wavelengths of 1,690 cm⁻¹ and 1,720 cm⁻¹, and
T is the thickness of the ion-exchange membrane.

2. The ion-exchange membrane according to claim 1, comprising a polyvinyl alcohol-containing polymer or a composition comprising the polymer.

3. The ion-exchange membrane according to claim 2, wherein the polyvinyl alcohol-containing polymer or the composition comprising the polymer comprises an ionic group.

4. The ion-exchange membrane according to claim 3, wherein the ionic group is an anionic group.

5. The ion-exchange membrane according to claim 3, wherein the ionic group is a cationic group.

6. A method for producing the ion-exchange membrane according to claim 1, comprising heat-treating a polyvinyl alcohol-containing polymer or a composition comprising the polymer.

7. The method according to claim 6, wherein the polymer is a block copolymer (BP) of formula (1): 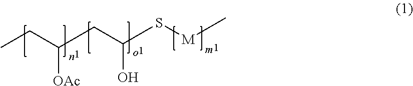
wherein
0.5000≦o¹/(n¹+o¹)≦0.9999;
0.01≦m¹/(m¹+n¹+o¹)≦0.50; and
M is a structural unit derived from a monomer M′ having an anionic group or a cationic group.

8. The method according to claim 6, wherein the polymer is a graft copolymer (GP) of formula (2): 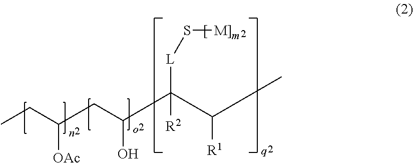
wherein
0.5000≦o²/(n²+o²)≦0.9999;
0.001≦q²/(n²+o²+q²)≦0.05;
0.01≦q² m²/(q² m²+n²+o²)≦0.50;
R¹ is a hydrogen atom or a carboxyl group;
R² is a hydrogen atom, a methyl group, a carboxyl group or a carboxymethyl group;
L is a divalent aliphatic hydrocarbon group having 1 to 20 carbon atoms optionally containing a nitrogen atom and/or an oxygen atom;
when R¹ is a carboxyl group or when R² is a carboxyl group or a carboxymethyl group, R¹ and R² may each form a ring with an adjacent hydroxyl group; and
M is a structural unit derived from a monomer M′ having an anionic group or a cationic group.
